(19) United States
(12) Patent Application Publication
(10) Pub. No.: US 2007/0242582 A1
(43) Pub. Date: Oct. 18, 2007

(54) Method and Apparatus for Determining the Quality of Optical Disk Read Signal

(75) Inventors: Hendrik Josephus Goossens, Eindhoven (CN); Bin Yin, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,432

(22) PCT Filed: May 27, 2005
(86) PCT No.: PCT/IB05/51735

§ 371 Date: Dec. 12, 2006

(30) Foreign Application Priority Data
Jun. 16, 2004 (CN) 200410059900.X

(51) Int. Cl. G11B 20/18

(52) U.S. Cl. 369/53.31

(57) ABSTRACT

The invention provides a method and apparatus 1, for determining the quality of the optical disk read signal. Said method comprises: comparing said optical disk read signal with a preset reference signal to acquire the signal values correlated with said preset reference signal in said optical disk read signal, with said correlated signal values satisfying a preset condition; sampling said optical disk read signal to acquire a, plurality of sampled signal values; acquiring, with respect to each of said signal values, two sampled signal values that are adjacent to each of said signal values according to said signal values and said sampled signal values; and finally determining the quality of said optical disk read signal on the basis of the preset relationship between the average and the maximum values of the differences of said two adjacent sampled signal values that are corresponding to each of the signal values.

### BACKGROUND ART

The present invention relates to the field of optical storage, particularly to a method and apparatus for determining the quality of the optical disk read signal.

Optical disk, as an optical storage medium with high density, has the advantages of large capacity, high compatibility and small volume, etc., and therefore, it has been widely used. However, some defects also exist in the manufacturing or keeping of optical disk, for example, uneven density, scratches, thin reflection layer, irregular groove, disk surface tilt, etc., these defects will influence the reading effect of data stored on the optical disk. In order to mitigate the influence of these defects on the effect of data reading, the optical disk drive (shortly referred as optical drive) should have strong error-correction capability during reading the data so as to read the optical disk at a minimum error rate. Therefore, the optical drive should be optimized in various ways during the process of storing and reading data, so that its error correction capability could be enhanced.

Usually, the optical drive is optimized by adjusting the optical elements in the optical drive or tuning the circuits therein. However, no matter which method is adopted, the quality of the signal read from the optical disk must be determined first, and on the basis of which, the optical drive could be optimized. At present, the determination of the quality of optical disk read signal uses the jitter value of the high frequency read signal as a quality evaluation parameter. The jitter value is the deviation between the real pulse width and the ideal pulse width and the distribution of the deviation after converting the high frequency signal generated by reading the optical disk information into binary signal. Since the jitter value is directly related to the data bit error rate, when the data jitter value characteristics are not good, there will certainly be high bit error rate; thus the size of jitter value directly reflects the correctness of read signal and therefore becomes an important index of evaluating the quality of the optical disk read signal.

However, there are some limitations in using the jitter value as the parameter for evaluating the quality of a read signal. Firstly, the jitter value is only effective within a certain range. When the optical drive reads an optical disk, the laser beam will focus on the corresponding position of the optical disk; accordingly, there is a jitter value of the read signal to reflect the quality of the read signal. If the tilt of said optical disk increases, the size of the spot of the laser beam focused on the optical disk will increase, i.e., the focusing quality of the laser beam is lowered, then the jitter value will correspondingly increase linearly. Nevertheless, if the tilt of said optical disk has exceeded a certain limitation, the jitter value will not be able to change linearly with the tilt of the optical disk any more. Generally speaking, if the jitter value exceeds 25%, it cannot change linearly with the tilt of the optical disk any more. Therefore, in a certain range of the tilt of the optical disk, the jitter value could reflect the quality of the optical disk read signal; while if said range is exceeded, the jitter value cannot correctly reflect the quality of the optical disk read signal any more.

Secondly, the measurement of the jitter value could only be performed in the synchronous domain of the bit detection, while as for data of asynchronous domain, the jitter value is no longer applicable. Since synchronous sampling (i.e., timing recovery) of data needs a high frequency signal the quality requirement of which is more strict, while many high frequency signals have noise interference, signal sampling cannot be performed at bit clock frequency, that is, only asynchronous domain sampling of the signal could be performed. However, jitter value is not applicable to data of asynchronous domain, so it cannot be used as a parameter for evaluating the quality of sampled signal of the asynchronous domain.

Therefore, there exists a need to provide a new method and apparatus for determining the quality of optical disk read signal to make the signal read by the optical drive reflected more accurately in a wider range, and to evaluate the quality of the optical disk read signal in the case of asynchronous domain.

### SUMMARY OF THE INVENTION

The present invention provides a method and apparatus for determining the quality of the optical disk read signal to overcome the disadvantages of the prior art.

The present invention provides a method for determining the quality of the optical disk read signal, comprising the steps of: comparing said optical disk read signal with a preset reference signal to acquire signal values correlated with said preset reference signal in said optical disk read signal, with said correlated signal values satisfying a preset condition; sampling said optical disk read signal to acquire a plurality of sampled signal values; acquiring, with respect to each of said signal values, two sampled signal values that are adjacent to each of said signal values according to said signal values and said sampled signal values; and determining the quality of said optical disk read signal according to the preset relationship between the average and the maximum values of the differences of said two adjacent sampled signal values that are corresponding to each of the signal values. In said method, sampling the optical disk read signal includes sampling the clock of the optical disk read signal. The two sampled signal values that are adjacent to each of said signal values acquired with respect to each of said signal values include two immediately adjacent sampled signal values. In the case of sampling the optical disk read signal clock, the relationship between the time values of the two sampled signal values with respect to each of the signal values and the time value of the corresponding signal value includes that the time value of each of said signal values is between the time values of said two sampled signal values with respect to the corresponding signal value.

The present invention further provides an apparatus for determining the quality of the optical disk read signal, comprising: comparing means for comparing said optical disk read signal with a preset reference signal to acquire signal values correlated with said preset reference signal in said optical disk read signal, with said correlated signal values satisfying a preset condition; sampling means for sampling said optical disk read signal according to a clock signal to acquire a plurality of sampled signal values; acquiring means for acquiring, with respect to each of said signal values, two adjacent sampled signal values according to said signal values and said sampled signal values; and determining means for determining the quality of said optical read signal according to the preset relationship between the average and the maximum values of the differences of the two adjacent sampled signal values that are corresponding to each of the signal values.

By means of the method and apparatus provided by the present invention, the quality of the optical disk read signal could be reliably measured in a wide range. In addition, the method and apparatus provided by the present invention could also evaluate the quality of sampled signal of asynchronous domain.

The other objects and achievements of the present invention will become obvious on the basis of the following description with reference to the figures and the claims, and meanwhile, a more comprehensive understanding of the present invention will also be obtained.

### DESCRIPTION OF FIGURES

The present invention will be described in detail in conjunction of embodiments with reference to the figures.

FIG. 1 is a block diagram showing an apparatus 100 for determining the quality of the optical disk read signal according to an embodiment of the present invention;

FIG. 2 is a flow chart of a method for determining the quality of optical disk read signal according to an embodiment of the present invention;

FIG. 3 is a schematic diagram of signal values and sampled signal values according to an embodiment of the present invention;

FIG. 4 is a schematic diagram of synchronous sampling around a zero level signal value according to an embodiment of the present invention;

FIG. 5 is a schematic diagram of the relationship between the average transition steepness and the tangential tilt according to the embodiment of FIG. 4 of the present invention;

FIG. 6 is a schematic diagram of the relationship between the average transition steepness and the radial tilt according to the embodiment of FIG. 4 of the present invention;

FIG. 7 is a schematic diagram of asynchronous sampling around a zero level signal value according to an embodiment of the present invention;

FIG. 8 is a schematic diagram of the relationship between the average transition steepness and the tilt of the optical disk according to the embodiment of FIG. 7 of the present invention;

FIG. 9 is a schematic diagram of another relationship between the average transition steepness and the tilt of the optical disk according to the embodiment of FIG. 7 of the present invention;

FIG. 10 is an eye pattern of a high frequency signal according to another embodiment of the present invention;

FIG. 11 is a schematic diagram of synchronous sampling around a clip shift level signal value according to another embodiment of the present invention; and

FIG. 12 is a schematic diagram of the relationship between the average transition steepness and the tilt of the optical disk according to the embodiment of FIG. 11 of the present invention.

In all the figures, the same reference numerals represent similar or same features and functions.

### DETAILED EMBODIMENTS

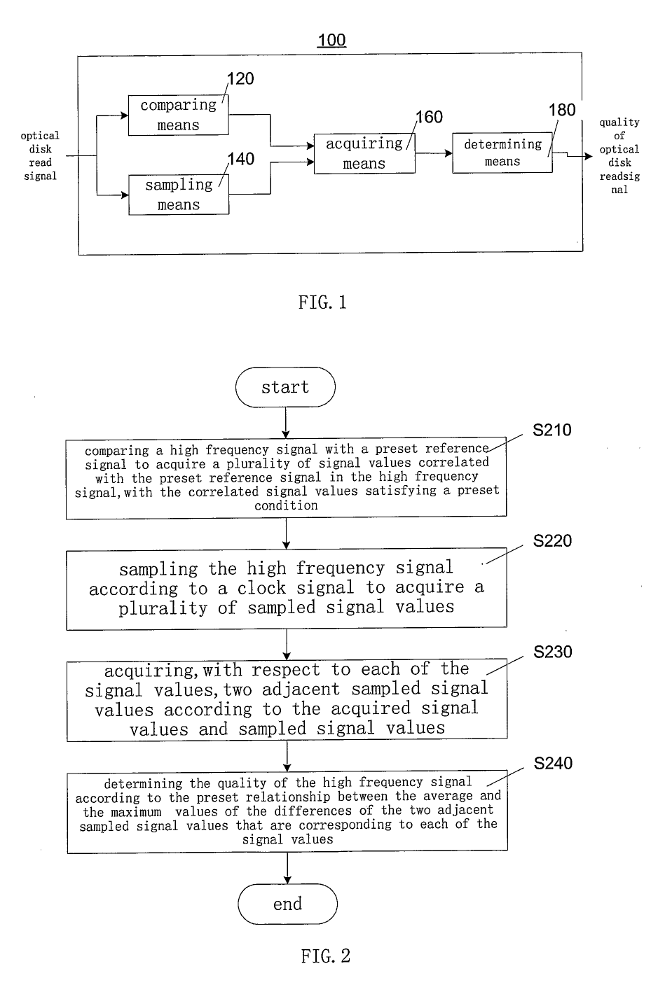

FIG. 1 is a block diagram showing an apparatus 100 for determining the quality of the optical disk read signal according to an embodiment of the present invention. Said apparatus 100 comprises comparing means 120 for comparing the optical disk read signal with a preset reference signal to acquire signal values correlated with said preset reference signal in said optical disk read signal, with said correlated signal values satisfying a preset condition, which is preferably that the acquired optical disk read signal values are equal to the preset reference signal.

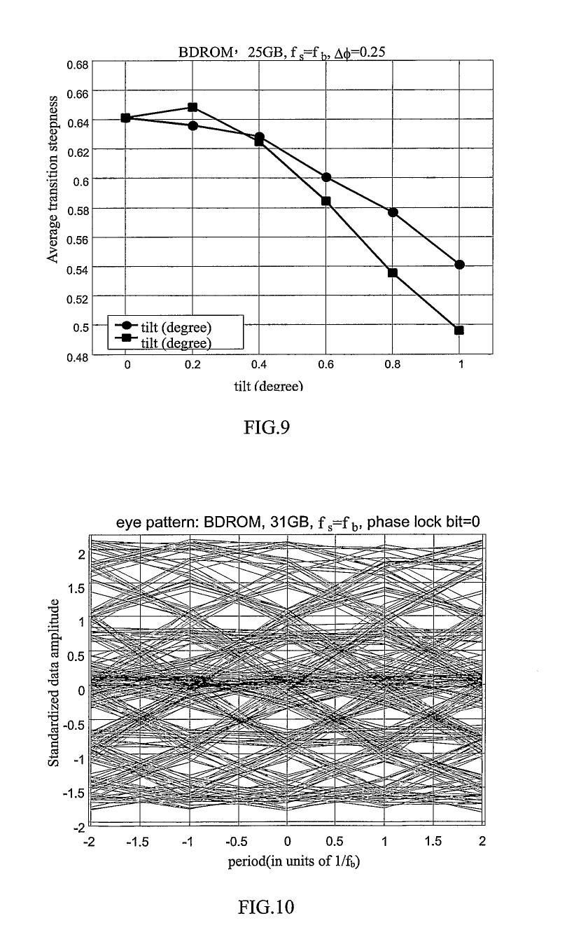

The preset reference signal comprises a reference signal set according to the optical disk read signal. In the present embodiment, said preset reference signal is selected as zero level because the sampling of the optical disk read signal is generally performed on the basis of zero level. However, in high density optical disk, the minimum signal pulse frequency of the zero level sampling is too high, thus making the amplitude thereof very small and highly sensitive to noise, and thereby the measuring of the signal quality is greatly disturbed. In another embodiment, a clip shift level aligned with the zero level is used as the preset reference signal, and the specific description thereof could be found in the following FIG. 10.

Said apparatus 100 further comprises sampling means 140 for sampling the optical disk read signal, for example, sampling the optical disk read signal according to a clock signal. In the optical disk storage system, if clock sampling is performed on the optical disk read signal, the higher the frequency of said clock signal is, the truer the recovery of the optical disk read signal is. For example, in a DVD, the frequency of the clock signal is generally 48 KHZ.

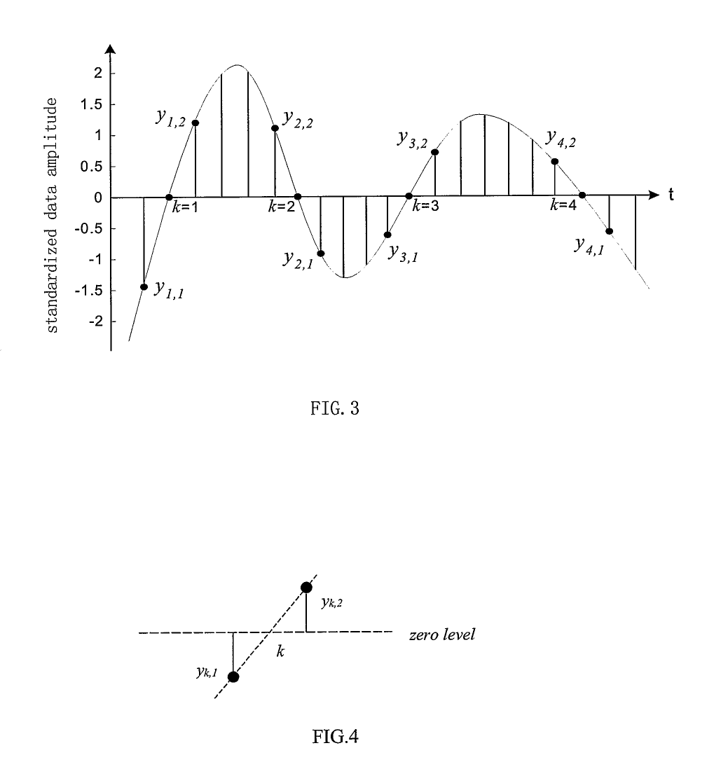

Said apparatus 100 further comprises acquiring means 160 for acquiring two adjacent sampled signals with respect to every signal value according to said signal values and sampled signal values, that is, said two adjacent sampled signal values include two sampled signal values adjacent to said signal value. Preferably, the clock sampling values acquired with respect to every signal value satisfy the requirement that the time value of a corresponding signal value is between the time values of said two adjacent sampled signal values. The acquisition of the sampled signal values will be illustrated in detail in the following FIG. 3.

Said apparatus 100 further comprises determining means 180 for determining the quality of said optical disk read signal according to the preset relationship between the average and the maximum values of the differences of said two adjacent sampled signal values that are corresponding to each of the signal values, and preferably for determining the quality of said optical disk read signal according to the preset relationship between the average and the maximum values of the differences of said two immediately adjacent sampled signal values that are corresponding to each of the signal values. The quality to be determined of the optical disk read signal includes the tilt of the optical disk, noise interference, Inter Symbol Interference (ISI), cross-talk (XT) between tracks, etc.

The preset relationship between the average and the maximum values of the differences includes, in the present embodiment, the ratio between the average and the maximum values of the differences. Said ratio is represented by the average transition steepness in the present embodiment, and the relationship between the average transition steepness and the quality of the optical disk read signal is that the quality of the optical disk read signal drops linearly with the smooth dropping of the average transition steepness.

The present embodiment further illustrates the method of the present invention by taking the determination of the tilt of the optical disk as an example. The tilt of the optical disk includes tangential tilt of the optical disk and radial tilt of the optical disk. The warp of the disk is caused by the stress generated by unevenness of drying or sticking and the warp could have different directions on the disk. The radial tilt is caused by radial tilt and radial warp, while tangential tilt is caused by tangential tilt and tangential warp. The tangential or radial tilt is the angular difference between the normal direction of the surface of the measured warp point on the tilt disk and the normal direction of the surface of the same measured point on a completely flat disk.

FIG. 2 is a flow chart of a method for determining the quality of optical disk read signal according to an embodiment of the present invention. The optical read signal in the present embodiment refers to a high frequency (HF) signal. The information on the optical disk is recorded on the information pit and information bank on the tracks of the optical disk information layer. During play, a scanning light spot is reflected by the reflective information layer, and the optical receiver receives the reflected light and converts it into electric signal which is just the high frequency signal. Said high frequency signal includes the disk information and the quality thereof directly affects the acquisition of data. The present embodiment determines the quality of high frequency signal by measuring the parameter of the average transition steepness.

The high frequency signal is compared with a preset reference signal to acquire a plurality of signal values correlated with said preset reference signal in the high frequency signal, with said correlated signal values satisfying a preset condition (step S210). This present condition is preferably that the acquired high frequency signal equals the preset reference signal. The preset reference signal includes a reference signal set according to the high frequency signal. Preferably, said preset reference signal is selected as a zero level and is compared with the high frequency signal so as to acquire k signal values that are equal to zero in the high frequency signal, 1≦k≦K, wherein K is an infinite integral. However, in view of practical application, K could be a finite integral. It should be noted that in high density optical disk, the sampled minimum signal pulse period around the zero level signal value is too short and disturbed by too much noise, therefore a clip shift level with the zero level being its reference could be selected as the preset reference signal so that the quality measuring will not be affected.

The high frequency signal is sampled to acquire a plurality of sampled signal values (step S220). In the present embodiment, the high frequency signal is sampled according to a clock signal and said clock sampling could be sorted into synchronous domain sampling and asynchronous domain sampling. The synchronous domain sampling means that the sampling frequency is the same as the bit clock frequency, i.e., the high frequency signal is sampled at the channel bit rate, which is also the bit clock frequency. The asynchronous domain sampling means that the sampling frequency is not the same as the clock frequency, or that the sampling frequency is the same as the clock frequency but there is phase difference between the real sampling instant and the most preferred sampling instant.

According to the acquired signal values and sampled signal values, two adjacent sampled signal values are acquired with respect to the every signal value (step S230). Preferably, said two adjacent sampled signal values include two sampled signal values that are immediately adjacent to said signal value. In the present embodiment, according to the acquired zero level signal value k and the sampled signal values of the high frequency signal, two immediately adjacent sampled signal values are acquired with respect to every zero level signal value, and said two sampled signal values are referred to as y_{k,1} and y_{k,2} (as shown in FIG. 4). The time value of said zero level signal value k is between the time values of the corresponding two immediately adjacent sampled signal values y_{k,1} and y_{k,2}, and the specific description thereof could be found in FIG. 4.

The quality of said high frequency signal is determined according to the preset relationship between the average and the maximum values of the differences of said two adjacent sampled signal values that are corresponding to each of the signal values (step S240). Preferably, the preset relationship between the average and the maximum values of the differences is the ratio between the average and the maximum values of the differences of the two immediately adjacent sampled signal values (y_{k,1} and y_{k,2}) around the zero level signal value k, and this ratio is also a parameter of the average transition steepness.

Said average transition steepness is calculated as shown in the following formula:

$$TranS = \frac{E \{ \vert {y}_{k , 2} - {y}_{k , 1} \vert \}}{max \{ \vert {y}_{k , 2} - {y}_{k , 1} \vert \}} \qquad ( 1 )$$

Wherein E{ } represents a mathematical expected value and is the average value of the differences of the two immediately adjacent sampled signal values of every zero level signal value k, and max{ } represents a maximum value and is the maximum value of the differences of the two immediately adjacent sampled signal values of every zero level signal value k.

For the sake of mathematical practical application, said formula could be approximated as:

$$TranS \approx \frac{\frac{1}{K} {\sum }_{1}^{K} \vert {y}_{k , 2} - {y}_{k , 1} \vert}{{max}_{1 \leq k \leq K} \{ \vert {y}_{k , 2} - {y}_{k , 1} \vert \}} , \qquad 2 )$$

Wherein TranS represents the average transition steepness. Theoretically, to acquire a true mathematical expected value, the number K of the zero level signals is an infinite number. However, as far as practical application is concerned, since we only need to acquire an approximation, this K could be a finite integral, but said approximation should be close to the mathematical expected value as much as possible.

The average transition steepness (TranS) acquired through the above calculation could be used to determine the quality of the high frequency signal. In the present embodiment, the method for determining the quality of signal is illustrated by taking the optical disk tilt as an example. Said optical disk tilt includes tangential tilt and radial tilt of the optical disk.

The correspondence relationship between said optical disk tangential tilt and the average transition steepness of said high frequency signal is that it could be determined that the optical disk tangential tilt increases continuously with the smooth dropping of the average transition steepness of said high frequency signal, and the specific description thereof could be found in FIG. 5. Since increasing the optical disk tangential tilt means increasing the focusing dimension of the laser spot beam and increasing the Inter Symbol Interference (ISI) of the signals, as long as the average transition steepness of this high frequency signal is calculated, the ISI and laser spot quality of the high frequency signal could be learnt according to the relationship between the tangential tilt and the average transition steepness.

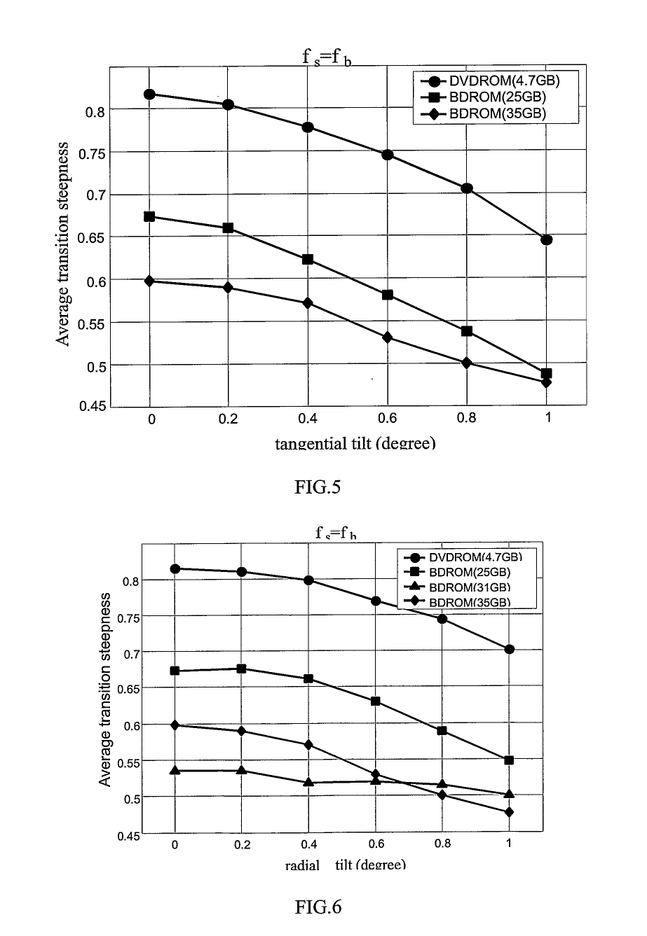

The correspondence relationship between said optical disk radial tilt and the average transition steepness of said high frequency signal is that the radial tilt of the optical disk increases with the smooth dropping of the average transition steepness of said high frequency signal, and the specific description thereof could be found in FIG. 6. Since increasing the radial tilt of the optical disk means increasing the cross-talk (XT) between the tracks, as long as the average transition steepness of said high frequency signal is calculated, the signal cross-talk quality of said high frequency signal could be learnt with reference to the relationship between said radial tilt and the average transition steepness.

FIG. 3 is a schematic diagram of signal values and sampled signal values according to an embodiment of the present invention. As shown in the figure, the preset reference signal is selected as zero level. Through the analog oscilloscope, we could see that in the high frequency signal, each of the plurality of signal values equal to said preset reference signal is k, k=1, 2, 3, 4 . . . (1≦k≦K). The two immediately adjacent sampled signal values acquired with respect to every zero level signal value k are y_{1,1} and y_{1,2}, y_{2,1} and y_{2,2}, y_{3,1} and y_{3,2}, y_{4,1} and y_{4,2} . . . y_{k,1} and y_{k,2} (1≦k≦K).

FIG. 4 is a schematic diagram of synchronous sampling around a zero level signal value according to an embodiment of the present invention. It could be seen in the figure that the zero level signal value is k, and with respect to every k, there are two immediately adjacent sampled signal values y_{k,1} and y_{k,2}, which are sampled in the synchronous domain. Assume that when the signal value k=1, y_{1,1} and y_{1,2} are respectively 1 and −1, and the difference between them is 2; when k=2, y_{2,1} and y_{2,2} are respectively 0.8 and −0.8, and the difference between them is 1.6; when k=3, y_{3,1} and y_{3,2} are respectively 0.7 and −0.7, and the difference between them is 1.4. Put the above numbers into formula (2), it could result in TranS=0.83((2+1.6+1.4)/3/2≈0.83). It should be noted that although the two immediately adjacent sampled signal values in this example and shown in FIG. 4 are symmetrical, they could also be unsymmetrical in fact. Due to some reasons, such as noise, inter signal interference (ISI) or inherent unsymmetrical signals, unsymmetrical sampled values will be produced.

FIG. 5 is a schematic diagram of the relationship between the average transition steepness and the tangential tilt according to the embodiment of FIG. 4 of the present invention. In FIG. 5, the high frequency signal qualities of three kinds of optical disks are measured, and these optical disks are DVD of 4.7 GB (DVDROM), blue-light disk of 25 GB (BDROM) and blue-light disk of 35 GB (BDROM), respectively. As shown in the figure, the X-coordinate is the tangential tilt and the Y-coordinate is the average transition steepness. Said average transition steepness is calculated by putting the acquired two immediately adjacent sampled signal values into formula (2), and the sampling frequency (fₛ) of said sampled signal values equals the bit clock frequency (f_{b}). It could be seen in the figure that the average transition steepnesses of these three kinds of optical disks all drop smoothly with the increase of the tangential tilt of the optical disks. In addition, it should be noted that when the tangential tilt is greater than 0.5°, i.e., when the jitter value is greater than 25%, the jitter value becomes meaningless to the measurement of quality. However, FIG. 5 shows that when the tangential tilt is greater than 0.5°, the average transition steepness still drops smoothly and it could still indicate the quality of the high frequency signal. Thus it means that the average transition steepness could reflect the quality of the high frequency signal in a wider range.

FIG. 6 is a schematic diagram showing the relationship between the average transition steepness and the radial tilt according to the embodiment of FIG. 4 of the present invention. In FIG. 6, the high frequency signal qualities of four kinds of optical disks are measured, and these kinds are DVD of 4.7 GB, blue-light disk of 25 GB, blue-light disk of 31 GB and blue-light disk of 35 GB, respectively. As shown in the figure, the X-coordinate is the radial tilt and the Y-coordinate is the average transition steepness. Said average transition steepness is calculated by putting the acquired two immediately adjacent sampled signal values into formula (2), and the sampling frequency (fₛ) of said sampled signal values equals the bit clock frequency (f_{b}). It could be seen in the figure that the average transition steepnesses of said four kinds of optical disks all drop with the increase of the radial tilt of the optical disk.

However, it could also be seen in FIG. 6 that said embodiment has different sensitivities for optical disks of different densities. For an optical disk of standard density (DVDROM of 4.7 GB and BDROM of 25 GB), said embodiment could work reliably and the average transition steepness drops effectively with the increase of the radial tilt. However, for the high density optical disk produced by reducing the optical disk bit length (BDROM of 31 GB and BDROM of 35 GB), the linear relationship between the average transition steepness and the radial tilt is not very obvious. The following FIGS. 10-12 describe another embodiment, which enables the present invention to be applicable to the quality determination of the high density optical disk read signal.

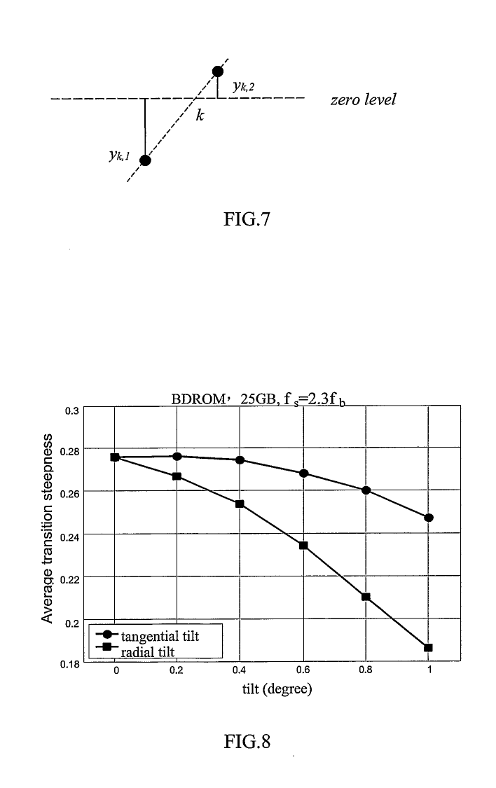

FIG. 7 is a schematic diagram of asynchronous sampling around a zero level signal value according to an embodiment of the present invention. The figure shows that the zero level signal value is k, and with respect to every k, there are two immediately adjacent sampled signal values y_{k,1} and y_{k,2}, which are sampled in the asynchronous domain. Asynchronous sampling means that the sampling frequency is not the bit clock frequency, or the sampling frequency is still the bit clock frequency but there is a phase difference between the real sampling instant and the most preferred sampling instant.

FIG. 8 is a schematic diagram showing the relationship between the average transition steepness and the tilt of the optical disk according to the embodiment of FIG. 7 of the present invention. In FIG. 8, the quality of the high frequency signal of the blue-light optical disk of 25 GB (BDROM) is measured. As shown in the figure, the X-coordinate is the tilt (including the tangential tilt and the radial tilt) of the optical disk and the Y-coordinate is the average transition steepness. Said average transition steepness is calculated by putting the acquired two immediately adjacent sampled signal values into formula (2), and the sampling frequency (fₛ) of said sampled signal values is 2.3 times of the bit clock frequency (f_{b}). It could be seen in the figure that the average transition steepness of the high frequency signal of said optical disk drops smoothly with the increase of the tilt of the optical disk, just as shown in FIGS. 5 and 6, and this means that the present invention is also effective for determining the quality of the asynchronous domain signal.

FIG. 9 is a schematic diagram showing another relationship between the average transition steepness and the tilt of the optical disk according to the embodiment of FIG. 7 of the present invention. In FIG. 9, the quality of the high frequency signal of the blue-light optical disk of 25 GB (BDROM) is measured. As shown in the figure, the X-coordinate is the tilt (including the tangential tilt and the radial tile) of the optical disk and the Y-coordinate is the average transition steepness. Said average transition steepness is calculated by putting the acquired two immediately adjacent sampled signal values into formula (2), and the sampling frequency (fₛ) of said sampled signal values equals the bit clock frequency (f_{b}), and there is a phase difference of 0.25 between the real sampling instant and the most preferred sampling instant. It could be seen in the figure that the average transition steepness of the high frequency signal of said optical disk drops with the increase of the tilt of the optical disk, and this means that the present invention is also effective for determining the quality of the asynchronous domain signal.

FIG. 10 is an eye pattern of the high frequency signal according to another embodiment of the present invention. It could be seen in the figure that we could observe the high frequency signal waveform of a blue-light optical disk of 31 GB through the analog oscilloscope, and the sampling frequency (fₛ) of said high frequency signal equals the bit clock frequency (f_{b}), and the phase lock bit=0. Due to the effect of the afterglow, a mesh graph, i.e., the eye pattern of the high frequency signal, is formed on the screen. There are some rhombuses in the graph, which are called eye graphs. The opening length in the longitudinal direction and the opening width in the transverse direction of these rhombic “eyes” indicate the good quality of the signal. The eye in the center of the graph is the “central eye” and the ones above and below said central eye are “sub-eyes”.

In FIG. 10, the X-coordinate is the period and the Y-coordinate is the standardized data amplitude. On the basis of the observation of FIG. 10, the modulation of the minimum pulse period of the high-density blue-light optical disk of 31 GB is very small, therefore even if there is no noise interference, the “central eye” has already almost closed. If the transition steepness of the minimum pulse period is still to be measured by using the zero level signal value as the reference signal, its result will be more or less randomly distributed and cannot truly reflect the average transition steepness.

However, we can see in FIG. 10 that the “sub-eyes” above and below the “central eye” are still very wide and large, so we could sample said “sub-eyes” and measure the average transition steepness, since the wider and larger the “eyes” are, the more accurate the average transition steepness measured are. Therefore, a clip shift level aligned with the zero level could be used as the reference signal to acquire the signal values that are equal to said clip shift level. In addition, in order to make up for the influence of the asymmetry of the high frequency signal on the quality measurement, two clip shift levels could be taken each from above and below the zero level and be used as the reference signals to measure the average transition steepnesses, and thereafter, the average of said two average transition steepnesses is taken as the final transition steepness.

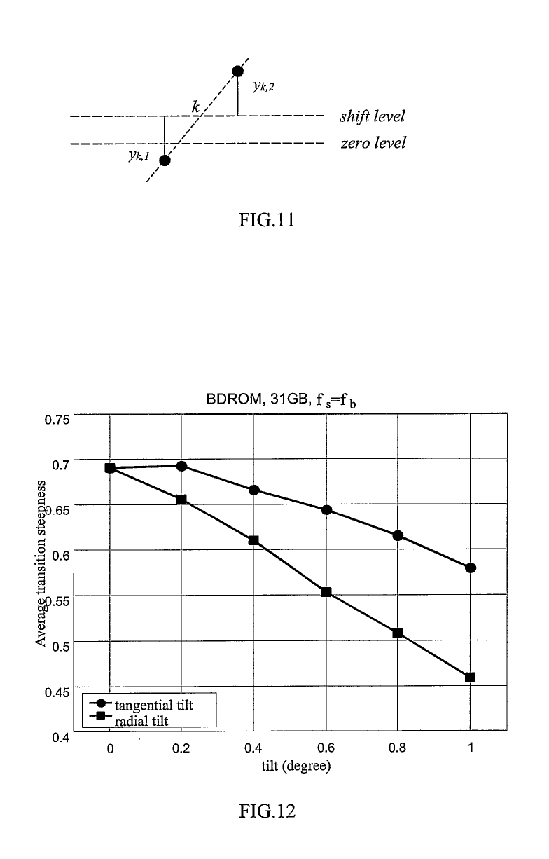

FIG. 11 is a schematic diagram of synchronous sampling around the clip shift level signal values according to another embodiment of the present invention. The figure shows that the reference signal is a clip shift level aligned with the zero level, and the signal value of said high frequency signal which equals said reference signal is k. With respect to every k, there are two immediately adjacent sampled signal values y_{k,1} and y_{k,2}, which are sampled in the synchronous domain. According to a test, the clip shift level is most preferably at the level of 0.5 or −0.5.

The method and apparatus for measuring the average transition steepness of the present embodiment are substantially the same as FIGS. 1 and 2 of the precedingly described embodiment. The only difference between them is that the present embodiment does not choose zero level as the reference signal in step S210, but chooses a clip shift level aligned with the zero level as the reference signal to acquire two immediately adjacent sampled signal values.

FIG. 12 is a schematic diagram of the relationship between the average transition steepness and the tilt of the optical disk according to the embodiment of FIG. 11 of the present invention. In FIG. 12, the high frequency signal of the blue-light optical disk of 31 GB (BDROM) is measured. As shown in the figure, the X-coordinate is the tilt of the optical disk (including the radial tilt and the tangential tilt) and the Y-coordinate is the average transition steepness. Said average transition steepness is calculated by putting the acquired two immediately adjacent sampled signal values into formula (2), and the sampling frequency (fₛ) of said sampled signal values equals the bit clock frequency (f_{b}). It could be seen in the figure that the average transition steepness of the high frequency signal of said optical disk drops smoothly with the increase of the tilt of the optical disk, which means that the present invention is also effective for determining the quality of the high frequency signal of high density optical disk.

The method and apparatus of the present invention could be applied to various optical disk systems, such as blue-light optical disk system, to adjust the aiming devices of the systems so as to compensate the changes of the thickness of the coating layers between optical disks. When the aiming device is moved, the quality of the optical disk read signal could be determined by observing the changes of the average transition steepness. When the average transition steepness is adjusted to its maximum value, it means that the quality of the optical disk read signal is the best, and also that the aiming device is adjusted to a best position.

The above-mentioned method and apparatus could be applied to determine the quality of the optical disk read signal of various existing formats.

Although the present invention is above described in conjunction of its specific embodiments, for those skilled in the art, it is obvious to make many substitutions, modifications and variations on the basis of the above description. Therefore, when such substitutions, modifications and variations fall into the spirit and scope of the appended claims, they should be included in the present invention.

1. A method of determining the quality of the optical disk read signal, comprising the steps of
(a) comparing said optical disk read signal with a preset reference signal to acquire signal values correlated with said preset reference signal in said optical disk read signal, and said correlated signal values satisfying a preset condition;
(b) sampling said optical disk read signal to acquire a plurality of sampled signal values;
(c) acquiring, with respect to each of said signal values, two sampled signal values that are adjacent to each of said signal values according to said signal values and said sampled signal values; and
(d) determining the quality of said optical disk read signal according to the preset relationship between the average and the maximum values of the differences of said two adjacent sampled signal values that are corresponding to each of the signal values.

2. The method as claimed in claim 1, wherein said preset reference signal includes a reference signal set according said optical disk read signal.

3. The method as claimed in claim 1, wherein the preset condition as stated in step (a) includes that said signal values are equal to said reference signal.

4. The method as claimed in claim 1, said sampling of said optical disk read signal comprises sampling said optical disk read signal according to a clock signal.

5. The method as claimed in claim 4, wherein said two adjacent sampled signal values as stated in step (c) include, with respect to each of signal values, two sampled signals that are adjacent to said signal value.

6. The method as claimed in claim 5, wherein the time value of each of said signal values is between the time values of said two sampled signal values with respect to said signal value.

7. The method as claimed in claim 1, wherein the preset relationship between the average and the maximum values of the differences of said two adjacent sampled signal values that are corresponding to each of the signal values as stated in step (d) includes the ratio between the average and the maximum values of said differences.

8. An apparatus for determining the quality of the optical disk read signal, comprising:
comparing means, for comparing said optical disk read signal with a preset reference signal to acquire signal values correlated with said preset reference signal in said optical disk read signal, with said correlated signal values satisfying a present condition;
sampling means, for sampling said optical disk read signal to acquire a plurality of sampled signal values;
acquiring means, for acquiring, with respect to each of said signal values, two adjacent sampled signal values according to said signal values and said sampled signal values; and
determining means, for determining the quality of said optical read signal according to the preset relationship between the average and the maximum values of the differences of said two adjacent sampled signal values that are corresponding to each of the signal values.

9. The apparatus as claimed in claim 8, wherein said acquired signal values correlated with said preset reference signal in said optical disk read signal include those signal values that are equal to said reference signal.

10. The apparatus as claimed in claim 8, wherein said two adjacent sampled signal values acquired with respect to each of said signal values include two sampled signal values that are immediately adjacent to said signal value.

11. The apparatus as claimed in claim 8, wherein said preset relationship between the average and the maximum values of the differences of said two adjacent sampled signal values that are corresponding to each of the signal values includes the ratio between the average and the maximum values of said differences.
